(19) United States
(12) Patent Application Publication
(10) Pub. No.: US 2025/0005908 A1
(43) Pub. Date: Jan. 2, 2025

(54) SYSTEM AND METHOD FOR DETERMINING PUPIL CENTER BASED ON CONVOLUTIONAL NEURAL NETWORKS

(71) Applicant: AMC Corporation, San Jose, CA (US)

(72) Inventor: Shengwei Da, San Jose, CA (US)

(73) Assignee: AMC Corporation, San Jose, CA (US)

(21) Appl. No.: 18/645,079

(22) Filed: Apr. 24, 2024

Related U.S. Application Data
(60) Provisional application No. 63/524,500, filed on Jun. 30, 2023.

(51) Int. Cl. G06V 10/774; G06T 7/73; G06V 10/82; G06V 40/18

(52) U.S. Cl. CPC G06V 10/774; G06T 7/73; G06V 10/82; G06V 40/193; G06T 2207/20081; G06T 2207/20084; G06T 2207/30201

(57) ABSTRACT

One embodiment of this disclosure can provide a system and method for training a machine learning model to detect pupil centers. During operation, the system can obtain a set of labeled pupil images, with a respective labeled pupil image comprising a pupil-segmentation label and a pupil-center-position label; construct a multitask machine learning model that includes a first branch for performing a pupil-region segmentation task and a second branch for performing a pupil-center-position regression task; and train the multitask machine learning model using the set of labeled pupil images. Training the multitask machine learning model comprises simultaneously training the first and second branches.

### RELATED APPLICATIONS

This disclosure claims the benefit of U.S. Provisional Application No. 63/524,500, Attorney Docket No. AMC23-1002PSP, entitled “SYSTEM AND METHOD FOR DETERMINING IRIS CENTER BASED ON CONVOLUTIONAL NEURAL NETWORKS,” by inventors Shengwei Da and Zhengming Fu, filed 30 Jun. 2023, the disclosure of which is incorporated herein by reference in its entirety for all purposes.

### BACKGROUND

### Field

The disclosed embodiments generally relate to gaze-tracking technologies. More specifically, the disclosed embodiments relate to detecting the center of a pupil using a multitask convolutional neural network (CNN).

### Related Art

Eye tracking or gaze tracking is one of the most crucial technologies in Human-Computer Interaction (HCl) and its applications. For example, gaze tracking can enhance the HCl user interfaces by allowing users to interact with devices using their gaze, such as selecting items or scrolling through content. In Augmented Reality (AR) and Virtual Reality (VR) environments, gaze tracking can contribute to a more immersive experience by allowing the system to respond to where the user is looking, thus enhancing realism and interaction. In autonomous driving environments, it can be used to detect driver drowsiness to enhance safety. Gaze tracking can also be used in human behavior research to understand cognitive processes, attention, and decision-making by analyzing where individuals focus their attention.

Gaze tracking systems typically use cameras and sensors to monitor eye movements and determine the point where a person is looking. For example, many VR/AR devices can include cameras (e.g., visible light or infrared cameras) installed internally to capture images of the user's eyes, and image features such as the shape and position of the pupil, eyelashes, and eye corners can be used to estimate the gaze point. Finding the center of the pupil is crucial to the accurate estimation of the gaze point.

### SUMMARY

One embodiment of this disclosure can provide a system and method for training a machine learning model to detect pupil centers. During operation, the system can obtain a set of labeled pupil images, with a respective labeled pupil image comprising a pupil-segmentation label and a pupil-center-position label; construct a multitask machine learning model that includes a first branch for performing a pupil-region segmentation task and a second branch for performing a pupil-center-position regression task; and train the multitask machine learning model using the set of labeled pupil images. Training the multitask machine learning model comprises simultaneously training the first and second branches.

In a variation on this embodiment, the multitask machine learning model can include a modified U-net.

In a variation on this embodiment, obtaining the labeled pupil images can include obtaining labeled images from an external pupil image database and annotating the labeled images by adding segmentation labels.

In a variation on this embodiment, training the multitask machine learning model can include computing a unified loss function that includes a segmentation loss function associated with the pupil-region segmentation task and a regression loss function associated with the pupil-center-position regression task.

In a further variation, computing the unified loss function can include computing a first regularization loss term based on a bounding box of a pupil region resulting from the pupil-region segmentation task and computing a second regularization loss term based on a pupil center position derived from the pupil region resulting from the pupil-region segmentation task.

In a further variation, training the multitask machine learning model can include running an initial set of training epochs using the unified loss function without the regularization terms and running a subsequent set of training epochs using the unified loss function with the regularization terms.

In a further variation, the segmentation loss function and the first and second regularization loss terms are weighted.

### DESCRIPTION OF THE FIGURES

FIG. 1 illustrates the exemplary architecture of a multitask neural network, according to one embodiment of the instant application.

FIG. 2 presents a flowchart illustrating an exemplary process for training a deep-learning neural network for predicting pupil centers, according to one embodiment of the instant application.

FIG. 3 illustrates an exemplary gaze-estimation process, according to one embodiment of the instant application.

FIG. 4 illustrates an exemplary pupil-center estimation system, according to one aspect of the instant application.

FIG. 5 illustrates an exemplary computer system that facilitates the estimation of pupil centers, according to one embodiment of the instant application.

In the figures, like reference numerals refer to the same figure elements.

### DETAILED DESCRIPTION

### Overview

This application discloses a method and system for precisely determining the position of pupil centers from eye images. More specifically, a multitask CNN (e.g., a U-net) can be constructed to include a segmentation branch and a regression branch. The segmentation branch can generate a segmentation output regarding the pupil region, and the regression branch can generate a regression output regarding the position of the pupil center. Both branches can be trained simultaneously with a mutual constraint. The segmentation task can constrain points of the regression task into the pupil region, and the regression of the pupil-center position can constrain the segmented region around the center point when there is partial occlusion of the pupil. The mutual constraint can enhance the robustness and accuracy of the detection of the pupil center.

### Multitask Machine Learning Model

Some conventional approaches for detecting/predicting pupil centers from eye images typically can include extracting low-level features (e.g., edges, lines, arcs, etc.) from the images to detect the boundaries of the pupils. Considering that pupils are approximately circular in shape, the center of each pupil can be derived from its circular boundary. Other approaches can include employing circle detection algorithms to locate circular shapes (which correspond to pupils) in an image or using a template matching technique to match a predefined pupil template to regions in the image.

The above techniques perform well when the pupil is clearly visible, and the boundaries are distinct. However, in many real-world scenarios, such as when the pupil is obscured by the eyelid or eyelashes or when there are reflections around the pupil area, these conventional techniques can be ineffective in accurately locating the pupil center.

Machine learning techniques have been used to deal with complex scenarios in pupil-center detection. For example, some approaches train a machine learning model (e.g., a deep-learning neural network) to use eye images as input and to output the position of the pupil center as a regression result. However, such approaches may lack robustness, because noisy images may cause the model to exhibit large fluctuations in predicting the position of the pupil center. Some approaches may use detection models to obtain the bounding box of a pupil and then calculate the position of the pupil center based on the bounding box. However, the direct object-detection scheme only works well for tasks that are not sensitive to small pixel offsets. When the pupil center is used to calculate the gaze point, even a small pixel offset can lead to significant deviations in the calculated gaze angle, thus greatly reducing the accuracy of the computed gaze point. Alternative approaches can include using a segmentation model to segment the pupil region in the image by classifying pixels as belonging to the pupil or not and then deriving the position of the pupil center. In some examples, to increase the robustness of the segmentation model against noise, a regularization term can be added to the design of the segmentation loss function in addition to the existing pixel-level loss function. For example, when training a CNN model for pupil segmentation, the algorithm can penalize non-convex shapes of the pupil caused by noise and reflections or fitting errors as a shape prior loss function in addition to the traditional cross-entropy loss function. However, when the pupil boundaries are unclear or occluded, segmentation can be difficult, which can lead to a significant reduction in the effectiveness of the approaches that solely rely on the segmentation algorithms for the calculation of the pupil-center position.

In general, the aforementioned single model (e.g., the regression model or the segmentation model) approaches may be insufficient in detecting the pupil center from eye images because some eye images are more suitable for segmentation than for direct regression of the pupil-center position, whereas others may not be conducive to segmentation but are suitable for direct regression of the pupil-center position.

In some embodiments of the instant application, instead of relying solely on one type of model (i.e., the segmentation model or the regression model) to predict the pupil-center position, the pupil-center detection system can implement a multitask CNN model to simultaneously perform a segmentation task and a regression task, thus enhancing the accuracy of the final predicted pupil center. This approach can effectively improve prediction accuracy, even in situations where the pupil features are not conducive to segmentation or center point regression.

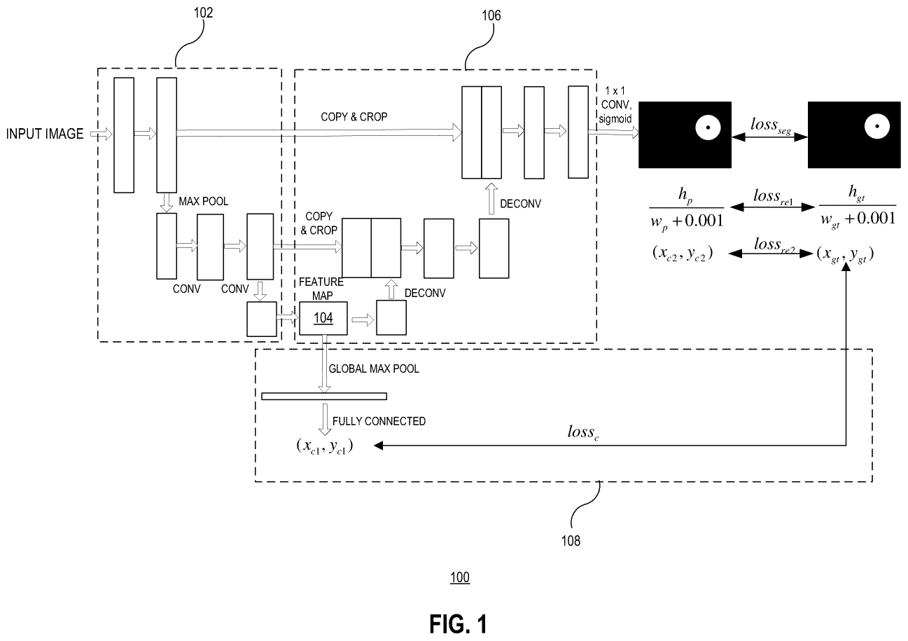

FIG. 1 illustrates the exemplary architecture of a multitask neural network, according to one embodiment of the instant application. In this example, a neural network model 100 can be a variation of a U-net, which was originally developed for image segmentation purposes. A typical U-net can include a contracting path and an expansive path, forming the U-shaped architecture. The contracting path is a typical convolutional network that includes repeated application of convolutions, each followed by a rectified linear unit (ReLU) and a max pooling operation. During contraction, the spatial information is reduced while the feature information is increased. The expansive path can combine the feature and spatial information through a sequence of up-convolutions and concatenations with high-resolution features from the contracting path.

In the example shown in FIG. 1, neural network model 100 can include an encoder 102 that can extract relevant features from an input image. Like the encoder in a conventional U-net, encoder 102 can include multiple convolutional (CONV) layers, followed by ReLU and max pooling. To reduce the consumption of computational resources, the depth and width of encoder 102 have been decreased compared with the conventional U-net model. The result of the encoding can be a feature map 104.

After encoding, neural network 100 can include two branches, a segmentation branch 106 and a regression branch 108. Segmentation branch 106 can be similar to the decoder of a conventional U-net and can be used to perform the segmentation of the pupil region. The decoder of the conventional U-net typically can include multiple transposed convolution (DECONV) layers that increase the size of the feature map and decrease the number of channels. The output of segmentation branch 106 can include a segmentation mask. More specifically, at the output of segmentation branch 106, a 1×1 convolution layer can be used to project the feature map into a probability map with two channels. One channel corresponds to the foreground of the pupil region, and the other channel corresponds to the background. A sigmoid function can be used as the activation function of the last layer. The foreground can be converted into a binary map of 0s and 1s (e.g., by applying a threshold of 0.5). In some embodiments, the segmentation algorithm can obtain a binary map containing only the segmented pupil region by identifying the largest connected region and removing other smaller connected regions. The position of the pupil center can then be obtained by computing the centroid of the segmented pupil region.

Regression branch 108 can include a simple global max-pooling layer and a fully connected layer for regression of the pupil center. In some embodiments, segmentation branch 106 and regression branch 108 can be trained simultaneously. The segmentation task carried out by segmentation branch 106 can constrain the points of the regression task carried out by regression branch 108 into the pupil region, and the regression of the pupil-center position can constrain the segmented pupil region around the pupil center when there is partial occlusion of the pupil.

The mutual constraint between the two branches can be reflected by the loss functions used in the model. The segmentation loss function loss_{seg} can include a Binary Cross-Entropy (BCE) loss function, and the pupil-center regression loss function loss_{c} can include a Mean Squared Error (MSE) loss function. In one example, the segmentation loss function can be expressed as:

$${loss}_{s e g} = {y}_{ip} log {y}_{igt} + ( 1 - {y}_{i p} ) log ( 1 - {y}_{igt} ) , \qquad ( 1 )$$

where y_{igt} is the ground truth label of the it pixel and yip is the predicted probability of the iₜₕ pixel.

The pupil-center regression loss function can be expressed as:

$${loss}_{c} = {( {x}_{gt} - {x}_{c 1} )}^{2} + {( {y}_{gt} - {y}_{c 1} )}^{2} , \qquad ( 2 )$$

where (x_{gt}, y_{gt}) is the ground truth of the pupil-center position, and (x_{c1}, y_{c1}) is the predicted position of the pupil center.

In the segmentation branch, the model can further include two regularization loss terms or regularization loss functions. The first regularization loss function lossᵣₑ₁ can be computed based on the height/width ratio of a minimum rectangular box bounding the segmented pupil region, expressed as:

$${loss}_{r e 1} = ( \frac{{h}_{p}}{{w}_{p} + 0.001} ) log ( \frac{{h}_{g t}}{{w}_{g t} + 0.001} ) + ( 1 - \frac{{h}_{p}}{{w}_{p} + 0.001} ) log ( 1 - \frac{{h}_{g t}}{{w}_{g t} + 0.001} ) , \qquad ( 3 )$$

where hₚ is the predicted height of the bounding box and h_{gt} is its ground truth value, and wₚ is the predicted width of the bounding box and w_{gt} is its ground truth value. Note that the small value (e.g., 0.001) added to the denominator is to prevent numerical instability (which can be caused by zeros at the denominator).

The second regularization loss function lossᵣₑ₂ can be computed based on the difference between the pupil center derived from the output of the segmentation model and the ground truth value of the pupil enter, expressed as:

$${loss}_{r e 2} = {( {x}_{gt} - {x}_{c 2} )}^{2} + {( {y}_{gt} - {y}_{c 2} )}^{2} , \qquad ( 4 )$$

where (x_{c2}, y_{c2}) is the position of the pupil center calculated based on the predicted segmentation result. The introduction of the two regularization terms can increase the robustness of the model in situations of occlusion or interference caused by reflections.

The unified loss function of the entire model (including both the segmentation branch and the regression branch) can be expressed as:

$$Loss = {loss}_{seg} + α {loss}_{c} + β ( {loss}_{r e 1} + {loss}_{r e 2} ) , \qquad ( 5 )$$

where α and β are hyperparameters. α indicates the weight of the regression task (i.e., the direct regression of the pupil center), and β indicates the weight of the regularization loss terms of the segmentation task. Training the two branches simultaneously using the unified loss function can increase the accuracy and robustness of the model. The segmentation task can constrain the points of the regression task into the pupil region, and the regression of the pupil center can constrain the segmented region around the pupil center when there is partial occlusion of the pupil. At the beginning of the training, the segmentation model cannot produce satisfactory segmentation results, and the output probability map is likely to be chaotic. Therefore, the first few training epochs (e.g., the initial 10 epochs) do not consider the regularization losses (i.e., β is set to zero). The regularization losses can be added to the united loss after the first few epochs. In some embodiments, in the first 10 epochs, a can be set as 0.7, and β can be set as 0, and in subsequent epochs, a can be set as 0.7, and β can be set as 0.3.

### The Training

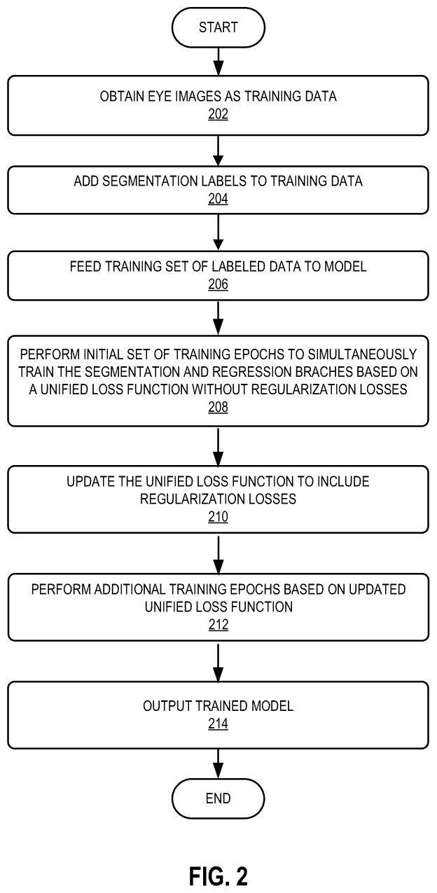

FIG. 2 presents a flowchart illustrating an exemplary process for training a deep-learning neural network for predicting pupil centers, according to one embodiment of the instant application. In one or more embodiments, one or more of the steps in FIG. 2 may be repeated and/or performed in a different order. Accordingly, the specific arrangement of steps shown in FIG. 2 should not be construed as limiting the scope of the technique.

During training, a plurality of eye images can be obtained as training data (operation 202). The eye images can be obtained by capturing facial images of volunteers using visible light or infrared cameras. Alternatively, the eye images can be obtained from existing pupil image datasets, such as the ExCuSe dataset and the Labeled Pupils in the Wild (LPW) dataset. The ExCuSe dataset includes 94,113 images with a size of 384×288, obtained from 24 participants, and the LPW dataset includes 130,856 images with a size of 640×480, derived from videos of 66 eye regions belonging to 22 participants. Both datasets cover diverse indoor and outdoor scenarios, including shadows, reflections, variations in lighting conditions, the presence of mascaras, eyeglasses, and eyelashes, and highly off-axis pupils. In some embodiments, a large number of images (e.g., 50,000 images) can be randomly selected from each image dataset as samples. In one embodiment, about 20% of the images in each dataset can be randomly selected as samples. Among the selected samples, 70% can serve as the training set, 10% as the validation set, and 10% as the test set.

The above image datasets only include labels (e.g., the (x, y) coordinates) of the pupil center. In some embodiments, segmentation labels can be added to the training data (operation 204). For example, one can use an annotation tool (e.g., LabelMe) to create a binary map of an image by setting the pixel values of pixels in the pupil region as “1” and the pixel values of pixels outside of the pupil region as “0.” The binary map can be used as the segmentation label. Note that it may not be feasible for the manual annotation to densely label all points on all boundaries. In some embodiments, the binary images can be smoothed using an ellipse fitting algorithm (e.g., a fitting algorithm from OpenCV). In certain situations, domain experts (e.g., algorithm engineers) may conduct a manual review of the labeled data to ensure the accuracy of the segmentation labels. In alternative embodiments, the annotation of the images can be performed automatically by algorithms without human intervention.

The training set of the labeled data can be fed to the model (operation 206). In some embodiments, the training data can be sent in batches, with the batch size set to 16. An initial set of training epochs can be performed to simultaneously train the segmentation and regression branches based on a unified loss function that does not include the regularization losses (operation 208). In some embodiments, the unified loss function can be similar to Equation (5) with α=0.7 and β=0. In some examples, the optimization algorithm used for training the model can include a stochastic gradient descent algorithm (e.g., Adam). The goal of the optimization is to minimize the unified loss function. In one example, the initial learning rate of the Adam algorithm can be 0.001, and the momentum can be 0.9. The initial set of training epochs can include between 5 and 15 epochs. In one example, this initial set can include 10 epochs.

Subsequent to performing the initial training epochs, the system can update the unified loss function to include the regularization losses (operation 210). As discussed previously, the regularization losses can include a first term determined based on the height and width of a minimum bounding box of the segmented pupil region and a second term determined based on the deviation of pupil center computed based on the segmented pupil region from the ground truth. In some embodiments, the weight of the regularization losses (i.e., β) in the unified loss function can be set as 0.3. Additional training epochs can be performed based on the updated unified loss function (operation 212). In some embodiments, the training of the model can include 30 epochs, with β=0 for the first 10 epochs and β=0.3 for the subsequent 20 epochs. Various machine learning platforms can be used to implement and train the neural network with two branches. In some embodiments, the neural network can be implemented and trained on PyTorch. The trained model can be outputted once all training epochs are performed (operation 214).

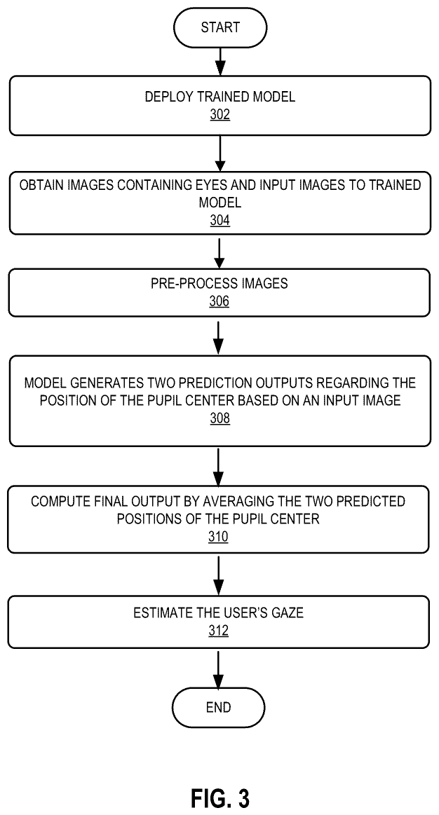

Once the model is trained, it can be used to detect pupil centers in images and to estimate gaze. FIG. 3 illustrates an exemplary gaze-estimation process, according to one embodiment of the instant application. During operation, the trained model can be deployed (operation 302). In some embodiments, the trained model can include a modified U-net with two branches and can be deployed to the cloud as a cloud application or to edge devices. Images containing eyes can be obtained and used as input to the trained model (operation 304). Depending on the application, the images can be obtained in situ by cameras, such as security cameras, webcams, cameras embedded in a pair of augmented reality (AR) or virtual reality (VR) glasses, etc. For example, if the trained model is used for estimating a user's gaze in an AR or VR environment, the embedded cameras can capture images of the user's eyes and send the images to the trained model. Alternatively, the images can be obtained offline.

Before applying the model, the input images can be pre-processed (operation 306). For example, standard image-processing techniques such as filtering and white balancing can be used to improve the quality of the input images. The trained model can generate two prediction outputs regarding the position of the pupil center based on an input image (operation 308). Each branch of the trained model can output a prediction. More specifically, the regression branch can directly output the first predicted position of the pupil center (denoted (x_{c1}, y_{c1})), and the segmentation branch can output a predicted binary segmentation map indicating the pupil region. The second predicted position of the pupil center (denoted (x_{c2}, y_{c2})) can be computed based on the segmented pupil region.

The final output of the trained model can be computed by averaging the two predicted positions of the pupil center (operation 310). For example, the position of the pupil center outputted by the trained model can be computed as:

$$( \frac{{x}_{c 1} + {x}_{c 2}}{2} , \frac{{y}_{c 1} + {y}_{c 2}}{2} ) .$$

The user's gaze can then be estimated based on the predicted position of the pupil center and additional information (operation 312). For example, the user's gaze can be estimated based on the predicted pupil center and the observed corneal reflections.

### The System

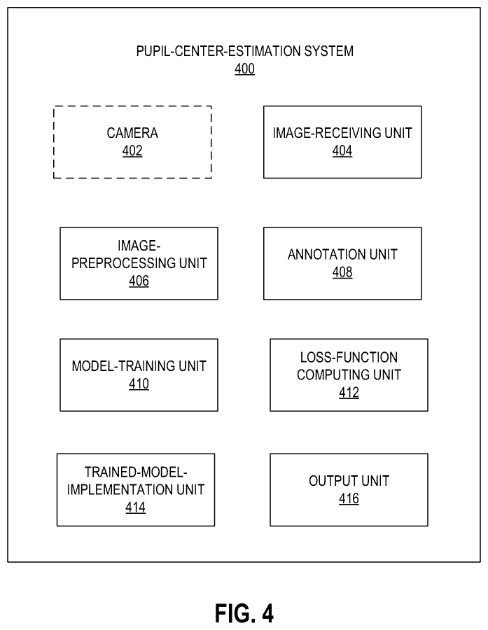

FIG. 4 illustrates an exemplary pupil-center estimation system, according to one aspect of the instant application. In FIG. 4, a pupil-center estimation system 400 can include an optional camera 402, an image-receiving unit 404, an image-processing unit 406, a model-training unit 408, a loss-function-computing unit 410, a trained-model-implementation unit 412, and an output unit 414. These units can be implemented using hardware, software, or a combination thereof.

Optional camera 402 can capture images of the user's eyes. In some embodiments, camera 402 can be a miniature camera embedded in the frame of a pair of AR or VR glasses. Image-receiving unit 404 can receive images from camera 402 or other sources. In some embodiments, the images can include training samples obtained from an external pupil-image database (e.g., ExCuSe and LPW) and can be labeled with pupil centers.

Image-processing unit 406 can be responsible for pre-processing the eye images. In some embodiments, image-processing unit 406 can apply filtering and white-balancing techniques to remove noise and improve the quality of the captured or received images. Annotation unit 408 can be responsible for annotating training samples. Standard pupil-detection training samples only include labels indicating the pupil center and do not include segmentation labels. In some embodiments of the instant application, annotation unit 408 can create segmentation labels for the training samples. In one example, a segmentation label can be a binary map indicating the pupil region.

Model-training unit 410 can be responsible for training a multitask machine learning model based on labeled training samples. More specifically, the multitask model can be a deep-learning neural network that includes two branches: a segmentation branch and a regression branch. The segmentation branch can be trained to perform a segmentation task that outputs a segmented pupil region, and the regression branch can be trained to perform a regression task that outputs a predicted location of the pupil center. The two branches can be trained simultaneously and can be mutually constrained based on a unified loss function that includes both the segmentation loss and the regression loss.

Loss-function computing unit 412 can be responsible for computing the loss functions, including the segmentation loss function, the regression loss function, and the unified loss function, that can be used by model-training unit 410 while training the multitask model. In some embodiments, loss-function computing unit 412 can compute the unified loss function as a sum of the segmentation loss and the regression loss. In one example, the segmentation loss can be weighted with a weight factor of 0.7. Moreover, after model-training unit 410 runs a number of initial epochs, loss-function computing unit 412 can add two regularization terms to the unified loss function, with the first regularization term determined based on the width-height ratio of the minimum rectangle bounding the segmented pupil region and the second regularization term determined based on the pupil center derived from the segmented pupil region. In one example, the regularization terms can also be weighted, with a weight factor of 0.3.

Training-model-implementation unit 414 can be responsible for implementing the trained multitask model to detect pupil centers in captured or received images. For example, a camera embedded in a pair of AR glasses can capture the user's eye images and send the eye images to training-model-implementation unit 414, which can input the images into the trained model and obtain outputs of the model, the outputs can include predicted pupil centers. Output unit 416 can be responsible for outputting the predicted pupil centers, thus allowing such information to be used in other applications, such as gaze-estimation applications.

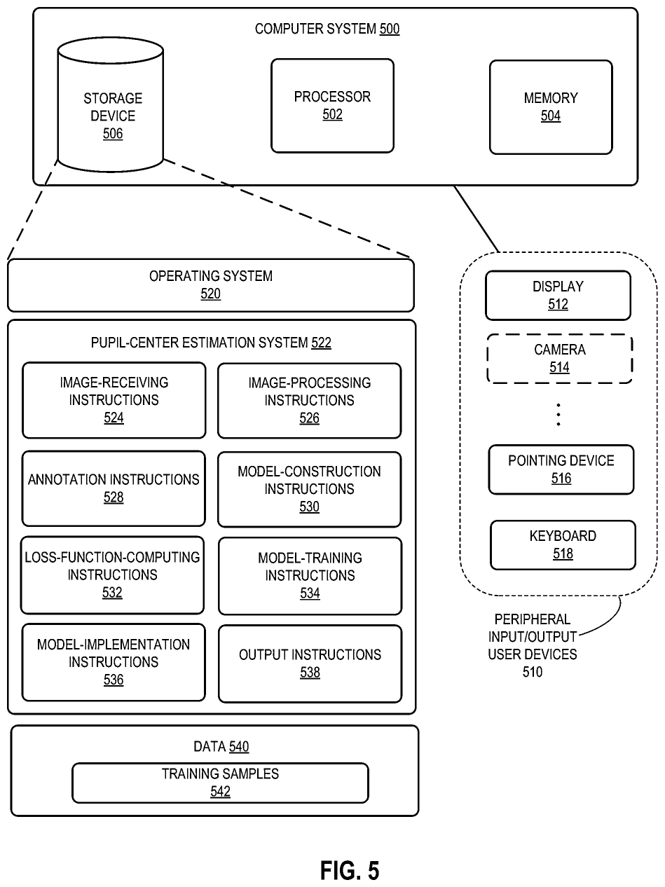

FIG. 5 illustrates an exemplary computer system that facilitates the estimation of pupil centers, according to one embodiment of the instant application. Computer system 500 includes a processor 502, a memory 504, and a storage device 505. Furthermore, computer system 500 can be coupled to peripheral input/output (I/O) user devices 510, e.g., a display 512, an optional camera 514, a pointing device 516, and a keyboard 518. Storage device 506 can store an operating system 520, a pupil-center estimation system 522, and data 540.

Pupil-center estimation system 522 can include instructions, which when executed by computer system 500, can cause computer system 500 or processor 502 to perform methods and/or processes described in this disclosure. Specifically, user-authentication system 522 can include instructions for receiving images from cameras or external databases (image-receiving instructions 524), instructions for processing the images (image-processing instructions 526, instructions for adding segmentation labels to training samples received from pupil database (annotation instructions 528), instructions for constructing a multitask deep-learning neural network (model-construction instructions 530), instructions for computing the various loss functions used for training the model (loss-function-computing instructions 532), instructions for training the multitask deep-learning neural network (model-training instructions 534), instructions for implementing the trained model (model-training instructions 536), and instructions for outputting the prediction of the pupil center position (output instructions 538). Data 540 can include training samples 542.

This disclosure describes a system and method for predicting pupil centers in eye images using a multitask machine learning model. The machine learning model can include a slightly modified U-net that includes two branches: a segmentation branch and a regression branch. The segmentation branch can perform a segmentation task to distinguish the pupil region from the background, and the regression branch can perform a regression task to estimate the position of the pupil center. Image samples in existing training datasets are only labeled with pupil centers. To facilitate training of the segmentation branches, those labeled samples should be annotated to the segmentation label (e.g., a binary map). The segmentation and the regression branches can be trained simultaneously to increase the robustness and accuracy of the model. The training purpose can be minimizing a unified loss function that is a linear combination of the segmentation loss and the regression loss. Moreover, two regularization loss terms can also be introduced after an initial set (e.g., 10) of training epochs. The regularization loss terms can be based on the height-width ratio of the minimum bounding box surrounding the segmented pupil region and the pupil-center position derived from the segmented pupil region.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method, comprising:
obtaining a set of labeled pupil images, wherein a respective labeled pupil image comprises a pupil-segmentation label and a pupil-center-position label;
constructing a multitask machine learning model that comprises a first branch for performing a pupil-region segmentation task and a second branch for performing a pupil-center-position regression task; and
training the multitask machine learning model using the set of labeled pupil images;
wherein training the multitask machine learning model comprises simultaneously training the first and second branches.

2. The method of claim 1, wherein the multitask machine learning model comprises a modified U-net.

3. The method of claim 1, wherein obtaining the labeled pupil images comprises:
obtaining, from an external pupil image database, pupil images with pupil-center-position labels; and
annotating the pupil images by adding segmentation labels.

4. The method of claim 1, wherein training the multitask machine learning model comprises computing a unified loss function that includes a segmentation loss function associated with the pupil-region segmentation task and a regression loss function associated with the pupil-center-position regression task.

5. The method of claim 4, wherein computing the unified loss function further comprises:
computing a first regularization loss term based on a bounding box of a pupil region resulting from the pupil-region segmentation task; and
computing a second regularization loss term based on a pupil center position derived from the pupil region resulting from the pupil-region segmentation task.

6. The method of claim 5, wherein training the multitask machine learning model comprises:
running an initial set of training epochs using the unified loss function without including the regularization terms; and
running a subsequent set of training epochs using the unified loss function with the regularization terms.

7. The method of claim 5, wherein the regression loss function and the first and second regularization loss terms are weighted.

8. A non-transitory computer readable storage medium storing instructions which, when executed by a processor, causes the processor to perform a method, the method comprising:
obtaining a set of labeled pupil images, wherein a respective labeled pupil image comprises a pupil-segmentation label and a pupil-center-position label;
constructing a multitask machine learning model that comprises a first branch for performing a pupil-region segmentation task and a second branch for performing a pupil-center-position regression task; and
training the multitask machine learning model using the set of labeled pupil images;
wherein training the multitask machine learning model comprises simultaneously training the first and second branches.

9. The non-transitory computer readable storage medium of claim 8, wherein the multitask machine learning model comprises a modified U-net.

10. The non-transitory computer readable storage medium of claim 8, wherein obtaining the labeled pupil images comprises:
obtaining, from an external pupil image database, pupil images with pupil-center-position labels; and
annotating the pupil images by adding segmentation labels.

11. The non-transitory computer readable storage medium of claim 8, wherein training the multitask machine learning model comprises computing a unified loss function that includes a segmentation loss function associated with the pupil-region segmentation task and a regression loss function associated with the pupil-center-position regression task.

12. The non-transitory computer readable storage medium of claim 11, wherein computing the unified loss function further comprises:
computing a first regularization loss term based on a bounding box of a pupil region resulting from the pupil-region segmentation task; and
computing a second regularization loss term based on a pupil center position derived from the pupil region resulting from the pupil-region segmentation task.

13. The non-transitory computer readable storage medium of claim 12, wherein training the multitask machine learning model further comprises:
running an initial set of training epochs using the unified loss function without including the regularization terms; and
running a subsequent set of training epochs using the unified loss function with the regularization terms.

14. The non-transitory computer readable storage medium of claim 12, wherein the regression loss function and the first and second regularization loss terms are weighted.

15. A computer system, comprising:
a processor; and
a storage device coupled to the processor, wherein the storage device storing instructions which, when executed by the processor, cause the processor to perform a method, the method comprising:
obtaining a set of labeled pupil images, wherein a respective labeled pupil image comprises a pupil-segmentation label and a pupil-position label;
constructing a multitask machine learning model that comprises a first branch for performing a pupil-region segmentation task and a second branch for performing a pupil-position regression task; and
training the multitask machine learning model using the set of labeled pupil images;
wherein training the multitask machine learning model comprises simultaneously training the first and second branches.

16. The computer system of claim 15, wherein the multitask machine learning model comprises a modified U-net.

17. The computer system of claim 15, wherein obtaining the labeled pupil images comprises:
obtaining, from an external pupil image database, pupil images with pupil-center-position labels; and
annotating the pupil images by adding segmentation labels.

18. The computer system of claim 15, wherein training the multitask machine learning model comprises computing a unified loss function that includes a segmentation loss function associated with the pupil-region segmentation task and a regression loss function associated with the pupil-center-position regression task.

19. The computer system of claim 18, wherein computing the unified loss function further comprises:
computing a first regularization loss term based on a bounding box of a pupil region resulting from the pupil-region segmentation task; and
computing a second regularization loss term based on a pupil center position derived from the pupil region resulting from the pupil-region segmentation task.

20. The computer system of claim 19, wherein training the multitask machine learning model further comprises:
running an initial set of training epochs using the unified loss function without including the regularization terms; and
running a subsequent set of training epochs using the unified loss function with the regularization terms.
